(19) United States
(12) Patent Application Publication
(10) Pub. No.: US 2024/0235340 A9
(43) Pub. Date: Jul. 11, 2024

(54) MAGNET ARRANGEMENT METHOD AND ROTOR MANUFACTURING METHOD

(71) Applicant: TOYOTA JIDOSHA KABUSHIKI KAISHA, Toyota-shi (JP)

(72) Inventor: Yushi TAKEUCHI, Nagakute-shi (JP)

(73) Assignee: TOYOTA JIDOSHA KABUSHIKI KAISHA, Toyota-shi (JP)

(21) Appl. No.: 18/548,247

(22) PCT Filed: Feb. 2, 2022
(86) PCT No.: PCT/JP2022/003942

§ 371 Date: Aug. 29, 2023

(30) Foreign Application Priority Data
Mar. 18, 2021 (JP) 2021-044582

(51) Int. Cl. H02K 15/03; H02K 1/2792

(52) U.S. Cl. CPC H02K 15/03; H02K 1/2792

(57) ABSTRACT

A magnet arrangement method in which magnetized magnets arranged in a Halbach array can be arranged at preset positions with a high accuracy is provided. The method includes an arrangement process of arranging a plurality of magnetized magnets in an arrangement jig made of a magnetic body, in which, in the arrangement process, a size of an area that the arrangement jig contacts a preset magnetized magnet is made different from a size of an area that the arrangement jig contacts another magnetized magnet.

### TECHNICAL FIELD

The present disclosure relates to a magnet arrangement method and a rotor manufacturing method, and relates to, for example, a method for arranging a plurality of magnetized magnets that are arranged in a Halbach array and a method for manufacturing a rotor including the plurality of magnetized magnets.

### BACKGROUND ART

In recent years, a rotor including magnets arranged in a Halbach array has been put to practical use. Such a rotor is manufactured, for example, by winding a magnet unit obtained by arranging a plurality of magnets in a Halbach array on a plate made of a steel strip thin sheet and fixing them by epoxy resin onto a rotor core, as disclosed in Patent Literature 1, or manufactured by arranging main magnetic pole permanent magnets and sub magnetic pole permanent magnets in a Halbach array using irregularities of a back yoke, as disclosed in Patent Literature 2.

### CITATION LIST

### Patent Literature

[Patent Literature 1] Japanese Unexamined Patent Application Publication No. 2018-107929
[Patent Literature 2] Japanese Unexamined Patent Application Publication No. 2007-110822

### SUMMARY OF INVENTION

### Technical Problem

Applicants have found the following problem. Although it is required that magnets arranged in a Halbach array be magnetized in advance, it is difficult to arrange these magnets at predetermined positions with a high accuracy.

The present disclosure has been made in view of the aforementioned problem, and provides a magnet arrangement method and a rotor manufacturing method capable of arranging magnetized magnets arranged in a Halbach array at predetermined positions with a high accuracy.

### Solution to Problem

A magnet arrangement method according to one aspect of the present disclosure is a method for arranging a plurality of magnetized magnets that are arranged in a Halbach array, the magnet arrangement method including an arrangement process of arranging the plurality of magnetized magnets in an arrangement jig made of a magnetic body, in which in the arrangement process, a size of an area that the arrangement jig contacts a preset magnetized magnet is made different from a size of an area that the arrangement jig contacts another magnetized magnet.

In the aforementioned magnet arrangement method, a concave part may be formed on a surface of the arrangement jig that contacts the magnetized magnet.

In the aforementioned magnet arrangement method, a concave part may be formed on a surface of the magnetized magnet that contacts the arrangement jig.

In the aforementioned magnet arrangement method, different magnetic poles may be arranged in such a way that the magnetic poles straddle a groove, which is the concave part.

In the aforementioned magnet arrangement method, when the plurality of magnetized magnets are arranged, a size of an area that one of the magnetized magnets provided on respective sides that form a magnetic loop contacts the arrangement jig is made smaller than a size of an area that the other one of the magnetized magnets provided on the respective sides that form the magnetic loop contacts the arrangement jig in such a way that the difference between an adsorption force that the magnetized magnet arranged on one side applies to the arrangement jig and an adsorption force that the magnetized magnet arranged on the other side applies to the arrangement jig is reduced.

A rotor manufacturing method according to one aspect of the present disclosure includes the aforementioned magnet arrangement method.

### Advantageous Effects of Invention

According to the present disclosure, it is possible to provide a magnet arrangement method and a rotor manufacturing method capable of arranging magnetized magnets arranged in a Halbach array at predetermined positions with a high accuracy.

### BRIEF DESCRIPTION OF DRAWINGS

FIG. 1 is a diagram showing a state in which a plurality of magnetized magnets are arranged on a surface of a positive Z-axis side of an arrangement jig in a magnet arrangement method according to an embodiment;

FIG. 2 is an enlarged view showing a II part in FIG. 1;

FIG. 3 is an enlarged cross-sectional view showing a state in which a plurality of magnetized magnets are arranged on the surface of the positive Z-axis side of the arrangement jig;

FIG. 4 is a diagram for describing a magnetic flux loop;

FIG. 5 is a perspective view showing a state in which a plurality of magnetized magnets are arranged on an outer peripheral surface of the arrangement jig;

FIG. 6 is a diagram showing a manufactured outer rotor; and

FIG. 7 is a cross-sectional view showing a magnetized magnet in which a concave part is formed.

### DESCRIPTION OF EMBODIMENTS

Hereinafter, with reference to the drawings, a specific embodiment to which the present disclosure is applied will be described in detail. However, the present disclosure is not limited to the following embodiment. Further, for the sake of clarification of the description, the following descriptions and the drawings are simplified as appropriate.

First, a magnet arrangement method according to this embodiment will be described. The following description will be given using three-dimensional (XYZ) coordinate systems for the sake of clarifying the explanation. The magnet arrangement method according to this embodiment is suitable when magnetized magnets are arranged in a Halbach array.

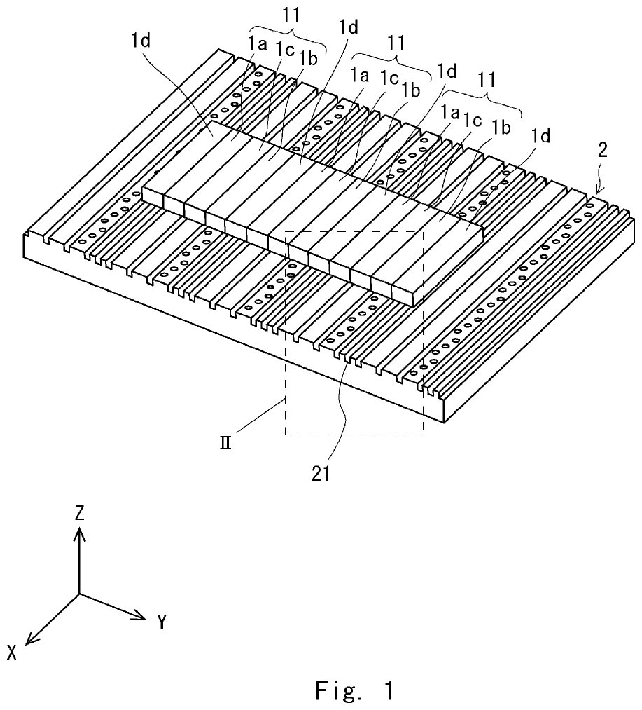

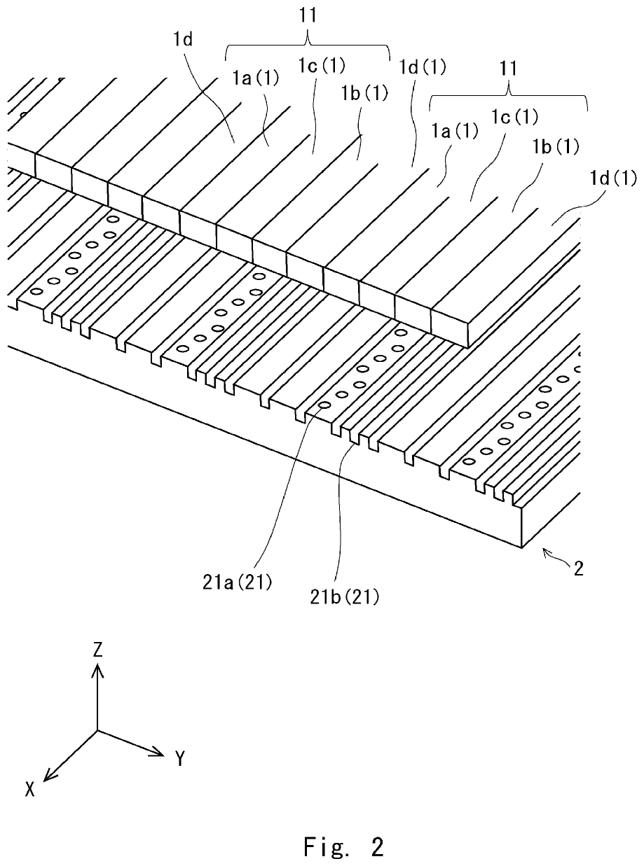

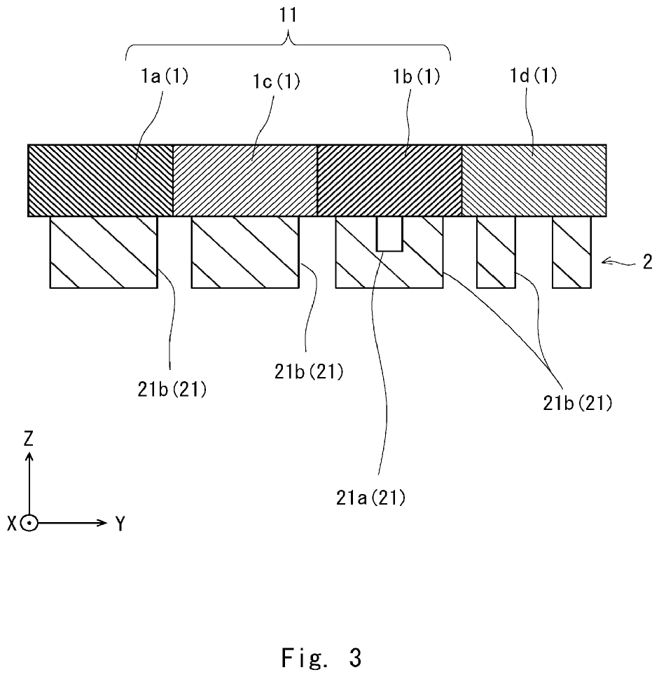

FIG. 1 is a diagram showing a state in which a plurality of magnetized magnets are arranged on a surface of a positive Z-axis side of an arrangement jig in a magnet arrangement method according to this embodiment. FIG. 2 is an enlarged view showing a II part of FIG. 1. FIG. 3 is an enlarged cross-sectional view showing a state in which a plurality of magnetized magnets are arranged on the surface of the positive Z-axis side of the arrangement jig.

In this embodiment, as shown in FIGS. 1 to 3, for example, magnetized magnets 1 are arranged in a Halbach array on the surface of the positive Z-axis side of an arrangement jig 2. Each of the magnetized magnets 1 has, for example, a quadrangular prism shape elongated in the X-axis direction, and has an N-pole part and an S-pole part so that a predetermined magnetic flux is generated. The magnetized magnets 1 are not limited to have a quadrangular prism shape and may have a columnar shape or another polygonal prism shape, and the shape of the magnetized magnets 1 is not limited.

The arrangement jig 2 is made of a magnetic body and has, for example, a plate shape as a basic form, as shown in FIGS. 1 to 3. Here, the arrangement jig 2 used in this embodiment has been conceived in order to solve the following problem when the magnetized magnets 1 are arranged.

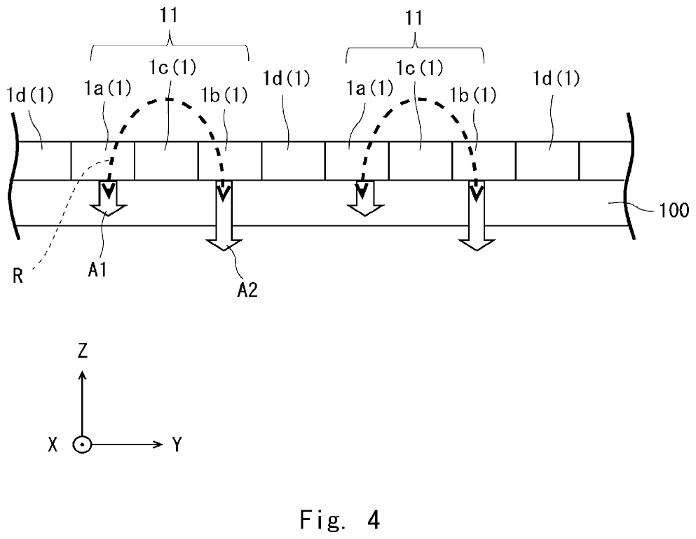

FIG. 4 is a diagram for describing a magnetic flux loop. It is assumed, for example, that three magnetized magnets 1 are arranged so that one magnetic flux loop R is formed by using the three magnetized magnets 1 as a set of magnet groups 11, as shown in FIG. 4.

That is, the set of magnet groups 11 includes, as three magnetized magnets 1, a first magnetized magnet 1a arranged on the negative Y-axis side, a second magnetized magnet 1b arranged on the positive Y-axis side, and a third magnetized magnet 1c arranged in the center. Then, as magnetized magnets 1 for reducing the magnetic flux between magnet groups 11 that are adjacent to each other, a fourth magnetized magnet 1d is arranged between the magnet groups 11 that are adjacent to each other.

When the magnetized magnets 1 thus arranged are arranged, for example, on the flat surface on the positive Z-axis side of a magnetic body 100 toward the positive Y-axis side, as shown in FIG. 4, in a magnetic flux loop R that a set of magnet groups 11 forms, the magnetic flux on the side of the second magnetized magnet 1b becomes larger than the magnetic flux on the side of the first magnetized magnet 1a.

Therefore, an adsorption force A2 of the second magnetized magnet 1b applied to the magnetic body 100 becomes larger than an adsorption force A1 of the first magnetized magnet 1a applied to the magnetic body 100, and thus it becomes more difficult to control the position of the second magnetized magnet 1b in a case where the second magnetized magnet 1b is arranged than in a case where the first magnetized magnet 1a is arranged. Further, when the second magnetized magnet 1b is arranged, the surface on the negative Z-axis side of the second magnetized magnet 1b rubs strongly against the flat surface on the positive Z-axis side of the magnetic body 100, which may cause damage to the surface of the negative Z-axis side of the second magnetized magnet 1b.

In addition, in a case where magnetic poles of magnetized magnets 1 that are adjacent to each other in the Y-axis direction are different from each other when the magnetized magnets 1 are arranged, a magnetic flux is generated between the different magnetic poles. Therefore, a magnetized magnet 1 newly arranged on the positive Y-axis side is affected by a magnetized magnet 1 adjacent to the above magnetized magnet 1 on the negative Y-axis side, and it becomes difficult to control the position of the magnetized magnet 1 newly arranged on the positive Y-axis side.

Further, in a case where opposing parts of magnetized magnets 1 that are adjacent to each other in the Y-axis direction are different magnetic poles from each other when the magnetized magnets 1 are arranged, an adsorption force may be generated between the magnetized magnets 1 that are adjacent to each other. In a case where opposing parts of magnetized magnets 1 that are adjacent to each other are magnetic poles equal to each other, a repulsive force may be generated between the magnetized magnets 1 that are adjacent to each other. Therefore, it becomes difficult to control the positions of the magnetized magnets 1.

In order to solve these problems, in the arrangement jig 2 according to this embodiment, as shown in FIGS. 1 to 3, concave parts 21 are formed on the positive Z-axis side of a surface of the arrangement jig 2 on which magnetized magnets 1 are arranged. In this embodiment, first concave parts 21a and second concave parts 21b are included as the concave parts 21.

The first concave parts 21a are formed in the position of the arrangement jig 2 where the second magnetized magnets 1b are arranged. As shown in FIGS. 1 to 3, the first concave parts 21a are, for example, substantially circular dimples when they are seen from the Z-axis direction, and are aligned in an S shape with intervals therebetween in the X-axis direction.

The first concave parts 21a may instead be aligned in a straight shape in the X-axis direction with intervals therebetween or may be aligned at random in the X-axis direction. Further, the first concave parts 21a are not limited to be substantially circular dimples and they may be polygonal or elliptical dimples or may have a groove shape.

In short, it is sufficient that the first concave parts 21a have such a shape and arrangement that the adsorption force of the second magnetized magnet 1b applied to the arrangement jig 2 is smaller than the adsorption force of the second magnetized magnet 1b applied to the magnetic body 100. At this time, the size of the area that the second magnetized magnet 1b contacts the arrangement jig 2 may be smaller than the size of the area that the first magnetized magnet 1a contacts the arrangement jig 2 in such a way that the difference between the adsorption force of the second magnetized magnet 1b applied to the arrangement jig 2 and the adsorption force of the first magnetized magnet 1a applied to the arrangement jig 2 is reduced.

When the magnetized magnets 1 are arranged in the arrangement jig 2, the second concave parts 21b are formed in a position where magnetic poles that are adjacent to each other straddle the second concave parts 21b. At this time, the second concave parts 21b may be arranged, for example, not only in the boundary part between the N-pole part and the S-pole part of the magnetized magnet 1 but also in the boundary part of magnetized magnets 1 that are adjacent to each other in the Y-axis direction. The arrangement of the second concave parts 21b shown in FIG. 1 and so on is merely one example and may be changed as appropriate depending on, for example, the arrangement of the N-pole parts and the S-pole parts of the magnetized magnets 1.

The second concave parts 21b, which are groove parts that are extended in the X-axis direction, have a length larger than the length of the magnetized magnets 1 in the X-axis direction. According to this configuration, it is possible to reduce the magnetic flux generated between different magnetic poles. At this time, when the magnetized magnets 1 are arranged in the arrangement jig 2, the width dimension of the second concave parts 21b in the Y-axis direction and the depth of the second concave parts 21b in the Z-axis direction are set in such a way that the adsorption force of the magnetized magnets 1 applied to the arrangement jig 2 becomes larger than an adsorption force or a repulsive force between magnetized magnets 1 that are adjacent to each other.

By repeating the process of arranging the magnetized magnets 1a, 1c, 1b, and 1d in the order of the first magnetized magnet 1a, the third magnetized magnet 1c, the second magnetized magnet 1b, and the fourth magnetized magnet 1d toward the positive Y-axis side on the surface of the positive Z-axis side of the arrangement jig 2 using the first concave parts 21a and the second concave parts 21b of the arrangement jig 2 as landmarks, the magnetized magnets 1 may be arranged in a Halbach array.

At this time, the size of the area that the second magnetized magnet 1b contacts the arrangement jig 2 is different from the size of the area that the first magnetized magnet 1a contacts the arrangement jig 2. Then, the first concave parts 21a are formed in such a way that the adsorption force of the second magnetized magnet 1b applied to the arrangement jig 2 becomes smaller than the adsorption force of the second magnetized magnet 1b applied to the magnetic body 100.

Therefore, it becomes easy to control the positions of the second magnetized magnets 1b when the second magnetized magnets 1b are arranged. In addition, when the first concave parts 21a have a shape of dimples, it is easy to visually check the positions where the second magnetized magnets 1b are arranged since the first concave parts 21a have a shape different from that of the second concave parts 21b.

By making the size of the area that the second magnetized magnet 1b contacts the arrangement jig 2 smaller than the size of the area that the first magnetized magnet 1a contacts the arrangement jig 2 in such a way that the difference between the adsorption force of the second magnetized magnet 1b applied to the arrangement jig 2 and the adsorption force of the first magnetized magnet 1a applied to the arrangement jig 2 is reduced, adsorption forces of all the magnetized magnets 1a, 1b, 1c, and 1d applied to the arrangement jig 2 can be substantially levelled. Therefore, it is possible to stabilize the control of the positions of the respective magnetized magnets 1.

Further, the second concave parts 21b are each arranged in the boundary part of different magnetic poles when the magnetized magnets 1 are arranged in the arrangement jig 2, whereby it is possible to reduce the magnetic flux that is generated between different magnetic poles. Therefore, it becomes easy to control the position of the magnetized magnet 1 newly arranged on the positive Y-axis side.

Further, when the magnetized magnets 1 are arranged in the arrangement jig 2, the second concave parts 21b are formed in such a way that the adsorption force of the magnetized magnet 1 applied to the arrangement jig 2 becomes larger than the adsorption force or the repulsive force between magnetized magnets 1 that are adjacent to each other. Therefore, it is possible to arrange a new magnetized magnet 1 on the positive Y-axis side so as to overcome the adsorption force or the repulsive force between magnetized magnets 1 that are adjacent to each other.

From the above description, according to the magnet arrangement method in this embodiment, the magnetized magnets 1 can be accurately arranged at predetermined positions. In addition, it is possible to reduce the adsorption force of the second magnetized magnet 1b applied to the arrangement jig 2, whereby it is possible to prevent the surface on the negative Z-axis side of the second magnetized magnet 1b and the arrangement jig 2 from rubbing strongly against each other, which prevents a damage from occurring on the surface of the negative Z-axis side of the second magnetized magnet 1b.

At this time, the second concave parts 21b are formed in the arrangement jig 2 in such a way that they are each arranged in a boundary part of the magnetized magnets 1 that are adjacent to each other. Therefore, when the magnetized magnets 1 are arranged, the magnetized magnets 1 may be arranged using the second concave parts 21b as landmarks. According to this configuration, it is possible to arrange the magnetized magnets 1 at predetermined positions in a simplified manner.

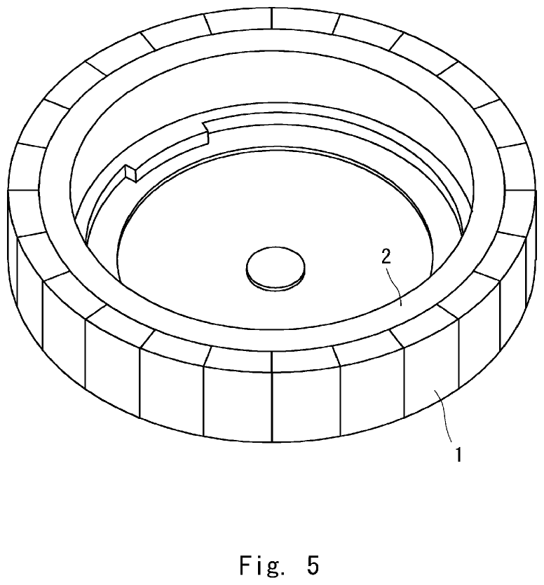

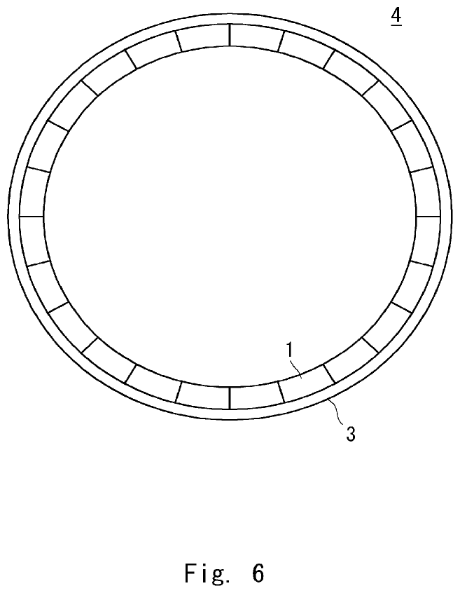

Next, a rotor manufacturing method will be described. FIG. 5 is a perspective view of a state in which a plurality of magnetized magnets are arranged on an outer peripheral surface of an arrangement jig. FIG. 6 is a diagram showing a manufactured outer rotor. FIG. 5 shows an arrangement jig 2 in a simplified manner, and concave parts 21 formed on the outer peripheral surface of the arrangement jig 2 are omitted. By forming the aforementioned arrangement jig 2 in, for example, a cylindrical shape as shown in FIG. 5, arranging the magnetized magnets 1 on the outer peripheral surface of the arrangement jig 2, and bonding these magnetized magnets 1 together, the magnetized magnets 1 can be arranged in a cylindrical shape.

As shown in FIG. 6, for example, by inserting magnetized magnets 1 arranged in a cylindrical shape inside the rotor core 3 having a cylindrical shape, bonding the inner peripheral surface of the rotor core 3 to the outer peripheral surface of the magnetized magnets 1, and attaching a rotation shaft that is not shown thereto, an outer rotor 4 can be manufactured. Instead, an inner rotor may be manufactured by fixing magnetized magnets 1 arranged in the cylindrical shape to the outer peripheral surface of the rotor core.

The present disclosure is not limited to the above-described embodiment and may be changed as appropriate without departing from the spirit of the present disclosure.

For example, while three magnetized magnets 1 form one magnetic flux loop R in the above-described embodiment, the number of magnetized magnets 1 for forming a magnetic flux loop R, the arrangement of magnetic poles, and the like are not limited.

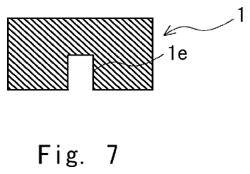

For example, while the concave parts 21 are formed in the arrangement jig 2 in the above-described embodiment, a concave part 1e may be formed in a magnetized magnet 1, as shown in FIG. 7. In summary, it is sufficient that concave parts be formed in at least one of the magnetized magnets 1 or the arrangement jig 2 in such a way that the adsorption force of one magnetized magnet 1 that forms a magnetic flux loop can be reduced or a magnetic flux that is generated between different adjacent magnetic poles can be reduced.

This application is based upon and claims the benefit of priority from Japanese Patent Application No. 2021-44582, filed on Mar. 18, 2021, the disclosure of which is incorporated herein in its entirety by reference.

### REFERENCE SIGNS LIST

1 Magnetized Magnet
1a First Magnetized Magnet
1b Second Magnetized Magnet
1c Third Magnetized Magnet
1d Fourth Magnetized Magnet
1e Concave Part
2 Arrangement Jig
3 Rotor Core
4 Outer Rotor
11 Magnet Group
21 Concave Part
21a First Concave Part
21b Second Concave Part
100 Magnetic Body
A1, A2 Adsorption Force
R Magnetic Flux Loop

1. A magnet arrangement method for arranging a plurality of magnetized magnets that are arranged in a Halbach array, the magnet arrangement method comprising an arrangement process of arranging the plurality of magnetized magnets in an arrangement jig made of a magnetic body, wherein
in the arrangement process, a size of an area that the arrangement jig contacts a preset magnetized magnet is made different from a size of an area that the arrangement jig contacts another magnetized magnet.

2. The magnet arrangement method according to claim 1, wherein a concave part is formed on a surface of the arrangement jig that contacts the magnetized magnet.

3. The magnet arrangement method according to claim 1, wherein a concave part is formed on a surface of the magnetized magnet that contacts the arrangement jig.

4. The magnet arrangement method according to claim 2, wherein different magnetic poles are arranged in such a way that the magnetic poles straddle a groove, which is the concave part.

5. The magnet arrangement method according to claim 1, wherein, when the plurality of magnetized magnets are arranged, a size of an area that one of the magnetized magnets provided on respective sides that form a magnetic loop contacts the arrangement jig is made smaller than a size of an area that the other one of the magnetized magnets provided on the respective sides that form the magnetic loop contacts the arrangement jig in such a way that the difference between an adsorption force that the magnetized magnet arranged on one side applies to the arrangement jig and an adsorption force that the magnetized magnet arranged on the other side applies to the arrangement jig is reduced.

6. A rotor manufacturing method comprising the magnet arrangement method according to claim 1.
